(19) United States
(12) Patent Application Publication
(10) Pub. No.: US 2013/0318045 A1
(43) Pub. Date: Nov. 28, 2013

(54) METHOD OF PRE-BROWSING AND CUSTOMIZING BROWSING DATA AND DIGITAL MEDIA DEVICE USING THE SAME

(71) Applicant: GEMTEK TECHNOLOGY CO., LTD., Hsinchu (TW)

(72) Inventors: Ju-Hung Hsiao, Tainan City (TW); Wei Wang, New Taipei City (TW)

(73) Assignee: GEMTEK TECHNOLOGY CO., LTD., Hsinchu (TW)

(21) Appl. No.: 13/745,870

(22) Filed: Jan. 21, 2013

(30) Foreign Application Priority Data
May 25, 2012 (TW) 101118720

(51) Int. Cl. G06F 17/30

(52) U.S. Cl. CPC G06F 17/30174
USPC 707/636

(57) ABSTRACT

A method of pre-browsing and customizing browsing data and a digital media device using the same are provided. The method includes following steps. In a step (a), a directory structure of a server is locally copied by recursively requesting to browse each node of the directory structure, where the directory structure has a plurality of levels, and each of the levels has at least one node. In a step (b), the step (a) is repeated on each of other servers so that the directory structures of all the servers are locally copied.

### CROSS-REFERENCE TO RELATED APPLICATION

This application claims the priority benefit of Taiwan application serial no. 101118720, filed on May 25, 2012, the entirety of the above-mentioned patent application is hereby incorporated by reference herein and made a part of this specification.

### BACKGROUND OF THE INVENTION

1. Field of the Invention

The invention generally relates to a method of pre-browsing and customizing browsing data, and more particularly, to a method of pre-browsing and customizing browsing data and a digital media device using the same.

2. Description of Related Art

The Digital Living Network Alliance (DLNA) provides an industrial standard that allows digital devices in digital homes or local area networks (LANs) to play, share, or print multimedia files. The DLNA standard is established based on the universal plug and play (UPnP) technique, and which integrates digital multimedia contents so that multimedia files (for example, pictures, music, movies, and playlists) can be conveniently shared.

DLNA certified devices can be categorized into digital media servers (DMSs), digital media players (DMPs), digital media controllers (DMCs), and digital media renderers (DMRs). A DMS transmits a description file of a multimedia file to a DMP or a DMC so that the multimedia file is played by the DMP or by a DMR through the DMC. A user can store multimedia data into a DMS (for example, a computer, a cell phone, a digital camera, or a camera) and then browse the multimedia data through a network by using a DMP.

In a DLNA certified system, a user can use a DMP to perform a browse action on a DMS and parse the XML response (i.e., a response in the XML format) to obtain the desired information. Herein the information is rendered to the user in any applicable mode, and the user can issue another browse request to a next level or return to the upper level according to the information rendered, for example, in a user interface.

In an existing DLNA certified system, a DMP does not browse a DMS on its own before a user issues a browse request to the DMS. In other words, the DMP issues browse requests to the DMS based on operation instructions of the user and through a network. FIG. 1 illustrates the operation procedure of a browse action in an existing DLNA certified system. As shown in FIG. 1, a digital media device 10, a network 12, a DMS 13, and a DMS 14 constitute a DLNA certified system. For the convenience of description, the operation procedure of a browse action in the existing DLNA certified system will be explained below by assuming that the digital media device 10 browses the DMS 13.

In the operation procedure of a browse action in the existing DLNA certified system, a user performs a browse action on a DLNA service 102 through a user interface 101 in the digital media device 10 (step 111). The DLNA service 102 then issues a browse request to the DMS 13 through a network according to the DLNA communication protocol (step 112). After that, the DMS 13 transmits a response data corresponding to the browse request in the XML format (i.e., a XML response) back to the digital media device 10 (step 113). The digital media device 10 parses the XML response and then displays information corresponding to the browse action in the user interface 101 (step 114). After that, the user can continue to browse the next level, return to the upper level, or play a multimedia file according to the displayed information.

However, in the operation procedure described above, the user may have to wait for the XML response from the appointed DMS when network traffic jam occurs. Besides, when the folder to be browsed by the user is on a lower level of the directory structure, it takes the DMS a longer time to run through the directory structure and respond to the digital media device, so that the operation of the user is made very inconvenient. Thereby, how to shorten the waiting time of a user for browsing folders or multimedia contents in a DMS has become a major subject.

### SUMMARY OF THE INVENTION

Accordingly, the invention is directed to a method of pre-browsing and customizing browsing data and a digital media device using the same, in which the waiting time of a user for browsing multimedia contents in a digital media server (DMS) is shortened through copying the directory structure of the DMS and a related update mechanism.

The invention provides a method of pre-browsing and customizing browsing data. The method is adapted to a digital media device and includes following steps. In a step (a), a directory structure of a server is locally copied by recursively requesting to browse each node of the directory structure. Herein the directory structure has a plurality of levels, and each of the levels has at least one node. In a step (b), the step (a) is repeated on each of other servers so that the directory structures of all the servers are locally copied.

According to an embodiment of the invention, the step of requesting to browse each node of the directory structure includes following steps. A browse request is issued regarding a node. A response corresponding to the browse request is received from the server corresponding to the node. The response is parsed to obtain a content of the node.

According to an embodiment of the invention, the at least one node includes a node representing a server, a folder, or a medium content.

According to an embodiment of the invention, in the step (a), the method further includes a step (c). In the step (c), by starting from a root node of the directory structure of the server, child nodes of a current node are recursively browsed according to the directory structure until all the child nodes of the current node have been browsed.

According to an embodiment of the invention, in the step (c), the method further includes following step. The directory structure of the server is recorded by using a tree data structure.

According to an embodiment of the invention, in the step (c), the method further includes following step. When all the child nodes of the current node have been browsed and at least one node on the same level as the current node has not been browsed, a node that is on the same level and has not been browsed is selected and the step (c) is executed on the node.

According to an embodiment of the invention, the method further includes following step. When a node to be selected by a user is already copied in a locally copied directory structure, the content of the node is directly obtained from the locally copied directory structure and rendered to the user, and no browse request is issued to the server corresponding to the node.

According to an embodiment of the invention, when the digital media device is turned on again, the steps (a), (b), and (c) are executed again to update the directory structures of all the servers.

According to an embodiment of the invention, when the digital media device is idle, the step (c) is executed in the background.

According to an embodiment of the invention, the method further includes following step. Every time when a browse request is issued regarding a node, a browse count of the node and a browse count of the server corresponding to the node are progressively increased.

According to an embodiment of the invention, the method further includes following step. A plurality of servers is sorted in a user interface according to the browse counts of the servers.

According to an embodiment of the invention, the directory structures of the servers are copied when the digital media device is turned on.

According to an embodiment of the invention, the directory structure of a server is copied after a user browses a node of the server for the first time,

According to an embodiment of the invention, the digital media device is a digital media player (DMP) or a digital media controller (DMC) compliant with the Digital Living Network Alliance (DLNA) standard.

According to an embodiment of the invention, the server is a DMS compliant with the DLNA standard.

The invention provides a digital media device suitable for pre-browsing and customizing browsing data. The digital media device includes a communication protocol module and a copying unit. The communication protocol module transmits a browse request to a server to browse a node of a directory structure of the server. The copying unit is connected with the communication protocol module. The copying unit executes a step (a). In the step (a), the copying unit locally copies the directory structure of the server by recursively issuing a browse request to the server regarding each node of the directory structure of the server. Herein the directory structure has a plurality of levels, and each of the levels has at least one node.

According to an embodiment of the invention, the copying unit also executes a step (b). In the step (b), the copying unit repeats the step (a) on other servers to locally copy the directory structures of all the servers.

According to an embodiment of the invention, the communication protocol module supports the DLNA standard. The communication protocol module issues a browse request regarding a node, receives a response corresponding to the browse request from the server corresponding to the node, and parses the response to obtain a content of the node.

According to an embodiment of the invention, the digital media device further includes a rendering unit connected with the communication protocol module and the copying unit. The rendering unit renders the content of a selected node in a user interface. When a node to be selected by a user is already copied in a locally copied directory structure, the rendering unit directly obtains the content of the node from the locally copied directory structure and renders the content of the node to the user, and the communication protocol module does not transmit any browse request to the server corresponding to the node.

According to an embodiment of the invention, the digital media device further includes a sorting unit connected to the communication protocol module, the copying unit, and the rendering unit. Every time when the communication protocol module transmits a browse request regarding a node, the sorting unit progressively increases a browse count of the node and a browse count of the server corresponding to the node.

As described above, the invention provides a method of pre-browsing and customizing browsing data. In the present method, the directory structures of all servers are locally copied by recursively requesting to browse each node of the directory structure of each server. The content of each node is directly obtained from the locally copied directory structure of the corresponding server and rendered to the user so that the number of browse requests issued to each server is reduced and the network transmission time is shortened. In addition, the browse counts of each node and each server are maintained, and the nodes or servers are sorted in a user interface according to their browse counts, so that the user operation is made very convenient.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram illustrating the operation procedure of a browse action in an existing Digital Living Network Alliance (DLNA) certified system.

FIG. 2 is a diagram illustrating the operation procedure of a browse action in a DLNA certified system according to an embodiment of the invention.

FIG. 3 is a diagram of a tree structure for copying a directory structure of a digital media server (DMS) according to an embodiment of the invention.

FIG. 4 is a functional block diagram of a digital media device according to an embodiment of the invention.

FIG. 5 is a flowchart of a method of pre-browsing and customizing browsing data according to an embodiment of the invention.

FIG. 6 is a flowchart of another method of pre-browsing and customizing browsing data according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The invention provides a method for pre-browsing digital media servers (DMSs) and customizing related browsing data in a digital media device supporting the Digital Living Network Alliance (DLNA) standard. The digital media device may be a digital media player (DMP) or a digital media controller (DMC) compliant with the DLNA standard. The DMSs are also compliant with the DLNA standard.

According to the invention, in the operation procedure of a browse action, after the digital media device is boot up and before a user performs any operation, all the servers connected to the digital media device are sequentially ran through (or browsed), and data in the directory structures of the servers is recursively browsed and locally saved. Herein a directory structure has a plurality of levels, and each of the levels has a node representing a folder or a multimedia file. When subsequently the user issues a browse request, the digital media device obtains the corresponding data from the pre-stored data and renders the data to the user. Thereby, the time for transmitting a browse request to a server and waiting for the server to respond to the digital media device can be avoided or shortened.

In addition, the number of DMSs in a household usually does not change very often even though the multimedia data in these DMSs is periodically updated. Thus, according to the invention, the weights of DMSs specified by a user or the weights of folders on the same level of a directory structure of a specific DMS can be respectively set according to the times that the user browses the DMSs or the times that the user browses the folders of the directory structure of the specific DMS. Moreover, the folders with higher weights are presented with high priority in the user interface than the folders with lower priority. Thereby, the browsing data presented in the user interface can be customized according to the habits or the friendly operation mode of the user.

Since the number of DMSs in a household seldom changes (i.e., a user always uses the same DMSs regularly), if data in these frequently-used DMSs is browsed and stored in a specific manner (for example, the directory structures of these DMSs are stored by using a tree structure) in advance, when subsequently a browse request regarding a specific folder in one of these frequently-used DMSs or in a specific DMS is received from the user, the corresponding data is simply obtained from the pre-stored data and presented in a user interface. Accordingly, the time for transmitting data between a digital media device and the DMSs is shortened. In addition, weights of the DMSs or weights of the folders in each DMS can be set according to the frequencies that the user selects the DMSs or the folders in each DMS, and those DMSs or folders that are frequently selected by the user are rendered on top of the list in the user interface for the convenience of the user. Namely, the presentation of the user interface is customized for the user.

Regardless of the type of the system architecture on which the DLNA protocol is realized, as long as the network is available, each DMS can be recursively browsed in the background after the system is turned on and before the user issues a browse request for the first time. Each browsed folder or multimedia file is considered as a node, and each DMS is considered as a root node. Because the directory structure of each DMS can be considered a tree data structure, a starting node (i.e., a root node) is set up as long as a DMS is detected. After that, the directory structure of the DMS is recursively browsed through the network. A XML response received every time when the DMS is browsed is parsed and a corresponding child node is set up until the entire directory structure is completely browsed.

By locally copying the directory structure of each DMS through the method described above, the directory structures of all of the DMSs can be set up before the user issues any browse request. When the user performs a browse action to a specific DMS, the DMS is not inquired through the network. Instead, the node to be browsed by the user is directly selected in the pre-established tree-shaped directory structure, and the content of the node is then obtained and rendered in the user interface. Thereby, the procedure for browsing a DMS or a folder is sped up.

In addition, because the directory structure of each DMS is pre-stored as a tree structure, the number of operations performed by the user on each DMS or the number of operations performed by the user on each node in each DMS can be recorded. The weight of each node (thereinafter, a root node represents a DMS, and which is also a node) can be set according to aforementioned operation times. When subsequently a specific node is ran through, the child nodes of the node can be sorted and rendered in the user interface according to the weights of the child nodes. Thereby, the time for the user to select a folder is shortened.

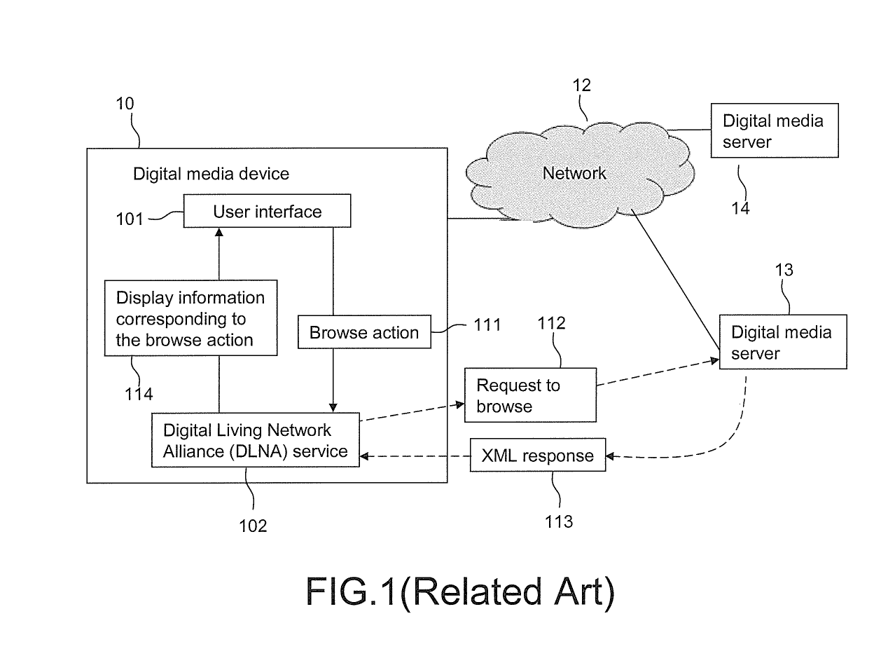

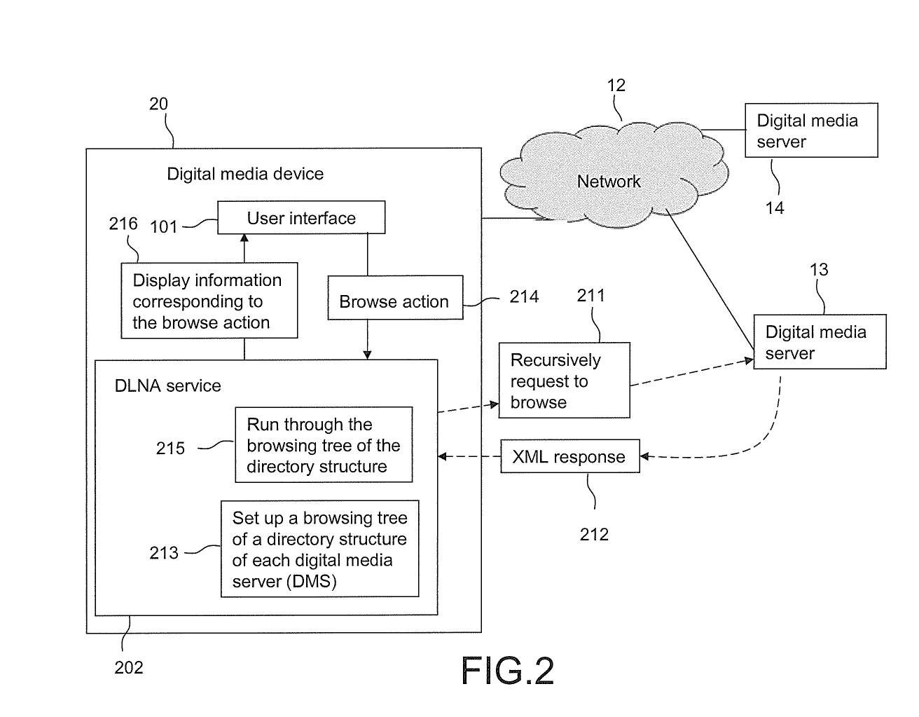

It can be understood based on the description related to FIG. 1 that a transmitting action and a receiving action have to be carried out through the network every time when the user performs a browse action. The entire processing procedure can be changed and accordingly the efficiency in DMS or folder browsing can be increased if aforementioned interim actions can be performed in advance. Below, the updated operation procedure will be described with reference to FIG. 2.

FIG. 2 is a diagram illustrating the operation procedure of a browse action in a DLNA certified system according to an embodiment of the invention. FIG. 2 is similar to FIG. 1, and the difference between the two drawings is that the DLNA service 202 of the digital media device 20 first executes the steps 211-213 and the step 215. Referring to FIG. 2, after the digital media device 20 is turned on and the network service is available, browse actions are respectively and recursively performed on the DMSs 13 and 14 as threads (or, the DMSs 13 and 14 are recursively requested to be browsed (step 211)), and XML responses are received. Below, for the convenience of description, the data transmission between the digital media device 20 and the DMS 13 will be described as an example.

A corresponding node is set up every time when a XML response is received from the DMS 13 (step 212). Once the recursive browse action is finished, a corresponding tree structure is locally set up (i.e., a directory structure of the DMS 13 is stored). Namely, in step 213, a browsing tree of the directory structure of each DMS is set up. Thereafter, when a user performs a browse action (step 214), the content of a node is obtained by directly and locally running through the browsing tree of the directory structure (step 215) instead of requesting to browse the DMS through network transmissions. Thereafter, the information corresponding to the browse action obtained from the local tree structure is displayed in a user interface (step 216). Accordingly, the time for network transmission, network reception, and parsing a XML response can be saved.

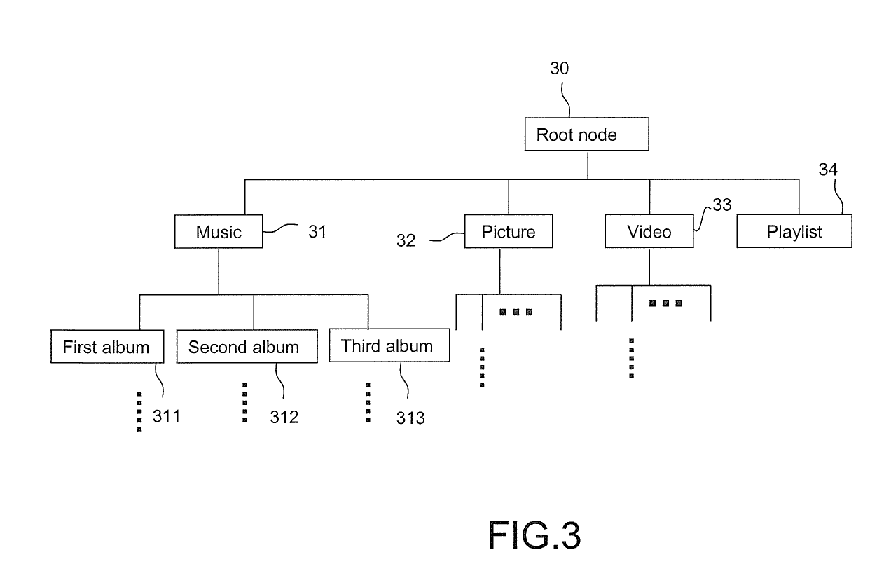

Below, how the weights are set will be explained with reference to FIG. 3. FIG. 3 is a diagram of a tree structure for copying a directory structure of a DMS according to an embodiment of the invention. The root node 30 represents a DMS, and the root node 30 has child nodes (for example, a music folder 31, a picture folder 32, a video folder 33, and a playlist 34) on a lower level. For the convenience of description, the child nodes of the picture folder 32, the video folder 33, and the playlist 34 are ignored, and only the child nodes (including a first album folder 311, a second album folder 312, and a third album folder 313) of the music folder 31 will be described. The first album folder 311, the second album folder 312, and the third album folder 313 may further have titles, types, artists, and dates respectively on the lower level.

Additionally, during the weight setting procedure, when the user performs a browse action on (or requests to browse) any node, a counting variable is added to the corresponding established node. The counting variable is increased by 1 every time when a browse action is performed on the node (or the node is requested to be browsed).

Thus, in foregoing step 216 (i.e., the information corresponding to a browse action is obtained from a local tree structure and rendered in a user interface), the display order of the information is adjusted according to the current weight of each node, and the information in the adjusted order is rendered in the user interface. For example, a user issues a browse request to a DMS represented by the root node 30, and the DMS responds that it has four child nodes, which are, in sequence, the music folder 31, the picture folder 32, the video folder 33, and the playlist 34. If the user views pictures for the most times and watches movies for the second most times, according to the browsing data customization method, the weight of the node corresponding to the picture folder 32 is greater than the weights of other nodes, and the weight of the node corresponding to the video folder 33 is greater than the weights of the music folder 31 and the playlist 34. Thus, the picture folder 32, the video folder 33, the music folder 31, and the playlist 34 are sequentially presented in the user interface so that the user can conveniently and quickly select the first folder (i.e., the picture folder 32) or the second folder (i.e., the video folder 33) to view pictures or watch movies.

Assuming that the next level of the picture folder 32 has 20 nodes corresponding to 20 folders, the time for the user to select a node is very different from that when the nodes are not sorted according to their weights. In other words, the user's experience in browsing the folders or nodes on a lower level of a directory structure when the nodes are sorted according to their weight is greatly improved. Moreover, customization of browsing data is realized by adjusting the order in which the nodes are rendered along with the change of the user's operation habits.

In the method of pre-browsing and customizing browsing data provided by the invention, a browse action (i.e., a request for browsing) is performed and a local tree structure is recursively set up once a digital media device is turned on, and subsequent browsing operations performed by the user are usually carried out by locally running through the tree structure in the digital media device. Thus, the browsing data may not be synchronized in real time in a real application. In the method of pre-browsing and customizing browsing data, real-time information may be lost since no more real-time browse request is issued to a DMS through the network after a tree structure of the directory structure of the DMS is established.

To be specific, if a DMS changes its multimedia files (adds new multimedia files or deletes existing multimedia files) after the digital media device sets up the local tree structure, since the digital media device does not request to browse the DMS through the network or obtain real-time information, a multimedia file to be played may no longer exist in the DMS, or a newly added multimedia file is not yet available to be browsed. Thus, a variation of the invention is provided herein. Namely, when a DMS adds or deletes a multimedia file and accordingly broadcasts related real-time information, a digital media device should perform a browse action regarding the node corresponding to the broadcasted information, so as to obtain the information and update the local directory structure. Thus, the consistency of the directory structure can be maintained. For example, according to the DLNA specifications, if a file in a DMS is modified, the related update information (indicating which node is updated) is broadcasted in the local area network (LAN), so that a digital media device can browse the node again to obtain the latest information and then update the local directory structure.

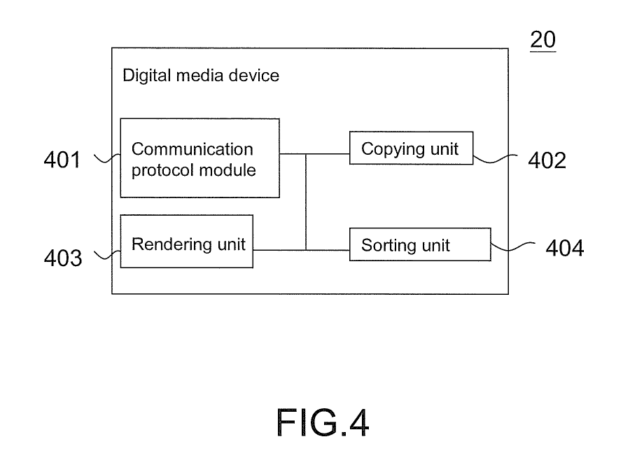

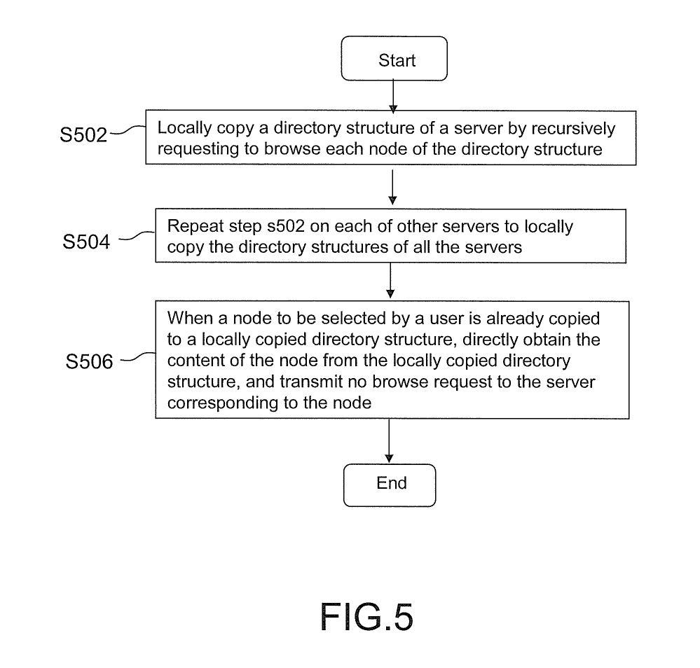

Based on the technical contents of the embodiments described above, a digital media device provided by the invention will be described in detail with reference to FIG. 4, and the operation procedure of the pre-browsing and browsing data customizing method provided by the invention will be described in detail with reference to FIG. 4 and FIG. 5.

FIG. 4 is a functional block diagram of a digital media device 20 according to an embodiment of the invention. The digital media device 20 includes a communication protocol module 401, a copying unit 402, a rendering unit 403, and a sorting unit 404. The digital media device 20 is suitable for pre-browsing and customizing browsing data.

Referring to FIG. 2 and FIG. 4, the communication protocol module 401 transmits a browse request to a DMS 13 to browse a node of a directory structure of the DMS 13. The communication protocol module 401 supports the DLNA standard. The communication protocol module 401 issues a browse request regarding a node, receives a response corresponding to the browse request from a server corresponding to the node, and parses the response to obtain the content of the node. The copying unit 402 connected with the communication protocol module 401 executes a step (a), in which the copying unit 402 locally copies a directory structure of the DMS 13 by recursively issuing a browse request regarding each node of the directory structure of the DMS 13. Herein the directory structure has a plurality of levels, and each of the levels has at least one node. In addition, the copying unit 402 also executes a step (b), in which the copying unit 402 repeats the step (a) on other DMSs (for example, the DMS 14 in FIG. 2) to locally copy the directory structures of all the servers respectively.

Aforementioned at least one node includes a node representing a DMS, a folder, a medium content, or a media file.

The copying unit 402 further executes a step (c), in which by starting from a root node of the directory structure of the DMS 13, the copying unit 402 recursively requests to browse the child nodes of a current node of the directory structure of the DMS 13 according to the directory structure until all the child nodes of the current node are browsed. Additionally, when the copying unit 402 executes foregoing step (c), the copying unit 402 records the directory structure of the DMS 13 by using a tree data structure. Moreover, when the copying unit 402 executes the step (c), if all the child nodes of a current node have been browsed but at least one node on the same level as the current node is not yet browsed, the copying unit 402 selects a node that is on the same level and is not yet browsed and executes the step (c) on the node. Below, how the copying unit 402 copies the directory structure of the DMS 13 will be explained in detail with reference to FIG. 3.

Referring to FIG. 3, the copying unit 402 first requests to browse the root node 30 and copies the content of the root node 30 to a local root node according to a XML response received from the DMS 13. Then, the copying unit 402 moves to a node on a next level (for example, the node representing the music folder 31) and copies the content of the node to the local tree structure. Since there is another level below the music folder 31, the copying unit 402 recursively copies the content of each node (for example, the first album folder 311) on the next level to the local tree structure. If all the child nodes of the first album folder 311 have been copied to the local tree structure while the contents of the second album folder 312 and the third album folder 313 on the same level have not yet been copied (or browsed), the copying unit 402 moves to the second album folder 312 to copy the content of each child node of the second album folder 312.

Foregoing procedure is repeated on the third album folder 313 to copy the contents of all the child nodes of the music folder 31 to the local tree structure. After that, the copying unit 402 moves to other folders on the same level as the music folder 31 to recursively copy the contents of these folders and all the child nodes thereof to the local tree structure.

According to an embodiment of the invention, the rendering unit 403, connected with the communication protocol module 401 and the copying unit 402, is configured to render the content of a selected node in a user interface. When a node to be selected by a user is already copied to a locally copied directory structure, the rendering unit 403 obtains the content of the selected node directly from the locally copied directory structure and renders the content to the user. Besides, in this case, the communication protocol module 401 does not transmit any browse request to the server corresponding to the node.

For example, when part of the directory structure of the DMS 13 has been locally copied and a folder or a node having a multimedia content to be selected by the user has been copied into the locally copied directory structure, the content of the node can be directly read from the locally copied directory structure instead of transmitting a browse request to the DMS 13 corresponding to the node. Thereby, the time for network transmission and parsing the XML response from the DMS 13 can be both saved.

Additionally, according to an embodiment of the invention, the sorting unit 404, connected to the communication protocol module 401, the copying unit 402, and the rendering unit 404, is configured to progressively increase a browse count of a node and a browse count of the server corresponding to the node every time when the communication protocol module 401 issues a browse request to the node. These browse counts are used for sorting the folder, the multimedia content, or the server corresponding to the node in a user interface.

It should be mentioned herein that in other embodiments of the invention, a digital media device may include only the communication protocol module 401 and the copying unit 402 but not the rendering unit 403 or the sorting unit 404. This is because the copying unit 402 can execute aforementioned steps (a), (b), and (c) without the rendering unit 403 and the sorting unit 404, and the digital media device can present the content of a node obtained from the locally copied directory structure in the user interface of a display device connected with the digital media device.

FIG. 5 is a flowchart of a method of pre-browsing and customizing browsing data according to an embodiment of the invention. Referring to FIG. 5, the pre-browsing and browsing data customizing method starts from step S502 and includes following steps. In step S502, the copying unit 402 recursively requests to browse each node of a directory structure of a DMS through the communication protocol module 401, so as to locally copy the directory structure. In step S504, the copying unit 402 repeats foregoing step S502 on other DMSs to locally copy the directory structures of all the DMSs. In step S506, when a node to be selected by a user is already copied in a locally copied directory structure, the rendering unit 403 directly obtains the content of the node from the locally copied directory structure and renders the content of the node to the user instead of transmitting a browse request to the DMS corresponding to the node.

In an actual application, the steps S502-S506 can be repeatedly executed to constantly update the directory structure of the DMS to the locally copied directory structure. In addition, it should be mentioned that the multimedia contents are not copied into the locally copied directory structure. Instead, the content of each node specified by the DLNA protocol is locally copied. To be specific, in the locally copied directory structure, the content of each node includes a node ID, a parent node ID (i.e., the ID of the node on the upper level), and a child node count. If a node itself represents a multimedia content, when the node is copied into the locally copied directory structure, only the network link corresponding to the multimedia content is copied.

It can be understood based on foregoing description that the method provided by the invention greatly eases the network traffic, and when the digital media device 20 is idle (i.e., the user is not trying to browse any folder or multimedia data of the DMS), the directory structure of the DMS is locally copied in the background.

To be specific, the operation of requesting to browse each node of a directory structure of a DMS in step S502 further includes following steps. First, a browse request is issued regarding a node. Then, a XML response corresponding to the browse request is received from the DMS corresponding to the node. Next, the XML response is parsed to obtain the content of the node. The directory structure of each DMS includes a plurality of levels, and each of the levels includes one or more nodes. Herein the one or more nodes include a node representing a server, a folder, or a medium content.

Moreover, the step S502, in which each node of the directory structure of a DMS is recursively browsed to locally copy the directory structure, further includes following step. By starting from a root node of the directory structure of the DMS, the copying unit 402 recursively requests to browse the child nodes of a current node in the directory structure of the DMS according to the directory structure until all the child nodes of the current node have been browsed. In addition, the copying unit 402 records the directory structure of a DMS by using a tree data structure.

To be specific, in the step of recursively requesting to browse the child nodes of a current node until all the child nodes of the current node have been browsed, when all the child nodes of the current node have been browsed but there is still one or more nodes on the same level as the current node that is not browsed yet, the copying unit 402 moves to a node on the same level that is not yet browsed and recursively requests to browse the child nodes of a current node until all the child nodes of the current node have been browsed.

In order to synchronize the locally copied directory structure with the directory structure of the DMS, in other embodiments, when the digital media device 20 is re-started, the copying unit 402 executes the steps S502 and S504 and by starting from a root node of the directory structure of the DMS, recursively requests to browse the child nodes of a current node in the directory structure of the DMS according to the directory structure until all the child nodes of the current node have been browsed.

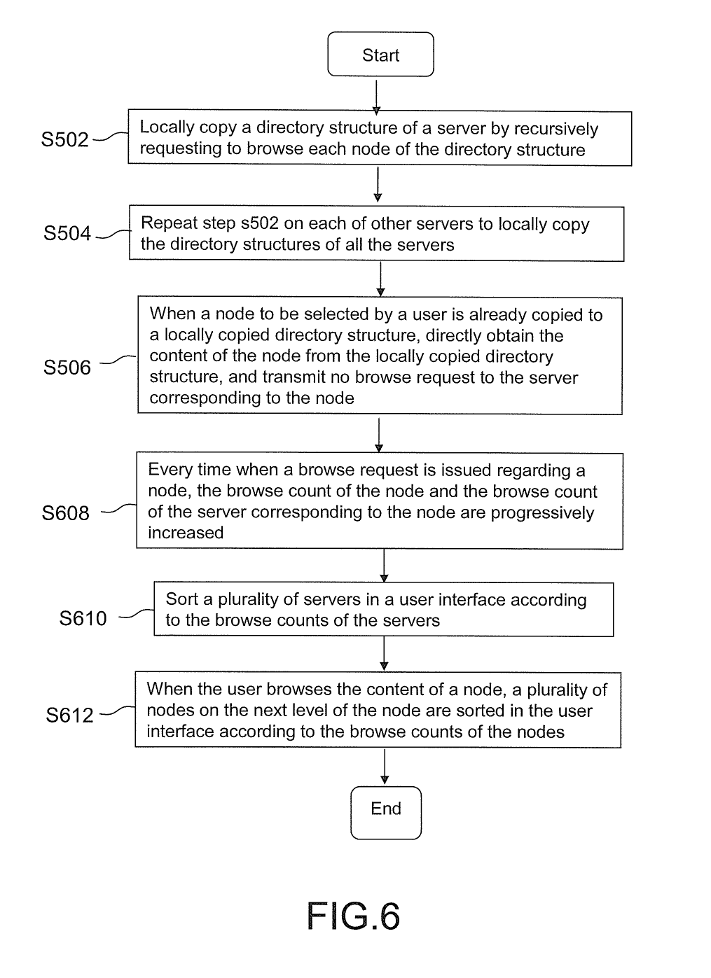

FIG. 6 is a flowchart of another method of pre-browsing and customizing browsing data according to an embodiment of the invention. The embodiment illustrated in FIG. 5 is improved in the present embodiment to include a method of sorting a plurality of DMSs or a plurality of nodes on the same level. Referring to FIG. 6, the pre-browsing and browsing data customizing method starts from step S502 and includes following steps. The steps S502-S506 in FIG. 6 have been described in the embodiment illustrated in FIG. 5 therefore will not be described herein.

Step S608 is executed after step S506. In step S608, every time when the communication protocol module 401 issues a browse request regarding a node, the sorting unit 404 progressively increases the browse count of the node and the browse count of the DMS corresponding to the node. In step S610, a plurality of DMSs is sorted in the user interface according to the browse counts of these DMSs. The step S610 allows those DMSs that are often selected by the user to be arranged on top of the list in the user interface when the user just turns on the digital media device 20 so that the user can see these DMSs instantly.

Similarly, in step S612, when the user is about to browse the content of a node, a plurality of nodes on the next level of the selected node is sorted in the user interface according to the browse counts of these nodes. Because those nodes that are often selected are arranged on the top of the list in the user interface, the user can instantly see those frequently selected folders or multimedia contents.

In an actual application, the steps S502-S612 can be repeatedly executed to constantly update the directory structure of the DMS to the locally copied directory structure.

Additionally, in an actual application, the copying unit 402 can start to copy the directory structure of a DMS when the digital media device 20 is turned on. However, in other embodiments, other operation patterns may be adopted. For example, the copying unit 402 starts to copy the directory structure of a DMS after the user browses a node of the DMS through the digital media device 20 for the first time.

As described above, the invention provides a method of pre-browsing and customizing browsing data. In the method provided by the invention, the directory structures of all servers are locally copied by recursively requesting to browse each node of the directory structure of each server. By directly responding to a user with the locally copied directory structures, the number of browse requests issued to the servers is reduced and the network transmission time is shortened. In addition, the nodes or servers rendered in a user interface are sorted according to the browse counts of the nodes or servers, so that the user's operation can be made very convenient.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method of pre-browsing and customizing browsing data, adapted for a digital media device, the method comprising:
(a) locally copying a directory structure of a server by recursively requesting to browse each of a plurality of nodes of the directory structure, wherein the directory structure comprises a plurality of levels, and each of the levels comprises at least one of the plurality of nodes; and
(b) repeating the step (a) on other servers to locally copy directory structures of all the servers.

2. The method according to claim 1, wherein the step of requesting to browse each of the plurality of nodes of the directory structure comprises:
issuing a browse request regarding one of the plurality of nodes, receiving a response corresponding to the browse request from the server corresponding to the node, and parsing the response to obtain a content of the node.

3. The method according to claim 2, wherein the at least one of the plurality of nodes represents a server, a folder, or a medium content.

4. The method according to claim 3, wherein in the step (a), the method further comprises:
(c) by starting from a root node of the directory structure of the server, recursively requesting to browse child nodes of a current node according to the directory structure until all the child nodes of the current node are browsed.

5. The method according to claim 4, wherein in the step (c), the method further comprises:
recording the directory structure of the server by using a tree data structure.

6. The method according to claim 5, wherein in the step (c), the method further comprises:
when all the child nodes of the current node are already browsed and at least one of the plurality of nodes on a same level to which the current node belongs is not yet browsed, selecting one of the plurality of nodes that is on the same level and is not yet browsed and executing the step (c) on the selected node.

7. The method according to claim 6 further comprising:
when the node selected by a user is already copied in a locally copied directory structure, directly obtaining a content of the selected node from the locally copied directory structure and rendering the content of the selected node to the user, but not transmitting a browse request to the server corresponding to the selected node.

8. The method according to claim 4, wherein when the digital media device is turned on again, the steps (a), (b), and (c) are executed again to update the directory structures of all of the servers.

9. The method according to claim 4, wherein when the digital media device is idle, the step (c) is executed in a background.

10. The method according to claim 2 further comprising:
every time when a browse request is issued regarding one of the plurality of nodes, progressively increasing a browse count of the node and a browse count of the server corresponding to the node.

11. The method according to claim 10 further comprising:
sorting a plurality of servers in a user interface according to the browse counts of the servers browsed by the digital media device.

12. The method according to claim 11 further comprising:
when a user selects to browse a content of a node, sorting at least one of the plurality of nodes on a next level in the user interface according to the browse count of the at least one of the plurality of nodes.

13. The method according to claim 1, wherein the directory structures of the servers are copied when the digital media device is turned on.

14. The method according to claim 1, wherein a directory structure of a server is copied after a user selects to browse one of the plurality of nodes of the directory structure of the server for a first time.

15. The method according to claim 1, wherein the digital media device is a digital media player (DMP) or a digital media controller (DMC) compliant with a Digital Living Network Alliance (DLNA) standard.

16. The method according to claim 1, wherein the server is a digital media server (DMS) compliant with a DLNA standard.

17. A digital media device, suitable for pre-browsing and customizing browsing data, the digital media device comprising:
a communication protocol module, configured to transmit a browse request to a server to browse one of a plurality of nodes of a directory structure of the server; and
a copying unit, connected with the communication protocol module, and configured to execute a step (a), wherein in the step (a), the copying unit locally copies a directory structure of a server by recursively requesting to browse each of the plurality of nodes of the directory structure, wherein the directory structure comprises a plurality of levels, and each of the levels comprises at least one of the plurality of nodes.

18. The digital media device according to claim 17, wherein the copying unit also executes a step (b), wherein in the step (b), the copying unit repeats the step (a) on other servers to locally copy directory structures of all the servers.

19. The digital media device according to claim 18, wherein the communication protocol module supports a DLNA standard, and the communication protocol module issues the browse request regarding one of the plurality of nodes, receives a response corresponding to the browse request from the server corresponding to the node, and parses the response to obtain a content of the node.

20. The digital media device according to claim 19, wherein the at least one of the plurality of nodes represents a server, a folder, or a medium content.

21. The digital media device according to claim 20, wherein the copying unit further executes a step (c), wherein in the step (c), by starting from a root node of the directory structure of the server, the copying unit recursively requests to browse child nodes of a current node according to the directory structure until all the child nodes of the current node are browsed.

22. The digital media device according to claim 21, wherein when the copying unit executes the step (c), the copying unit records the directory structure of the server by using a tree data structure.

23. The digital media device according to claim 22, wherein when the copying unit executes the step (c), when all the child nodes of the current node are already browsed and at least one of the plurality of nodes on a same level to which the current node belongs is not yet browsed, the copying unit selects one of the plurality of nodes that is on the same level and is not yet browsed and executes the step (c) on the selected node.

24. The digital media device according to claim 23 further comprising:
a rendering unit, connected with the communication protocol module and the copying unit, and configured to render a content of the selected node in a user interface, wherein when one of the plurality of nodes selected by a user is already copied in a locally copied directory structure, the rendering unit directly obtains a content of the selected node from the locally copied directory structure and renders the content of the selected node to the user, and the communication protocol module does not transmit a browse request to the server corresponding to the selected node.

25. The digital media device according to claim 23, wherein when the digital media device is turned on again, the copying unit executes the steps step (a), (b), and (c) again to update the directory structures of all the servers.

26. The digital media device according to claim 23, wherein when the digital media device is idle, the copying unit executes the step (c) in a background.

27. The digital media device according to claim 24 further comprising:
a sorting unit, connected to the communication protocol module, the copying unit, and the rendering unit, and configured to progressively increase a browse count of one of the plurality of nodes and a browse count of the server corresponding to the node every time when the communication protocol module issues a browse request regarding the node.

28. The digital media device according to claim 27, wherein the sorting unit sorts a plurality of servers in a user interface according to the browse counts of the servers browsed by the digital media device.

29. The digital media device according to claim 28, wherein when a user selects to browse a content of one of the plurality of nodes, the sorting unit sorts at least one node on a next level in the user interface according to the browse count of the at least one node.

30. The digital media device according to claim 17, wherein the copying unit starts to copy the directory structures of the servers when the digital media device is turned on.

31. The digital media device according to claim 17, wherein the copying unit starts to copy a directory structure of a server after a user selects to browse one of the plurality of nodes of the directory structure of the server for a first time.

32. The digital media device according to claim 17, wherein the digital media device is a DMP or a DMC compliant with a DLNA standard.

33. The digital media device according to claim 17, wherein the server is a DMS compliant with a DLNA standard.
